(19) United States
(12) Patent Application Publication
(10) Pub. No.: US 2026/0261144 A1
(43) Pub. Date: Sep. 3, 2026

(54) NETWORK AND METHOD FOR PERFORMING CONTROLLER AREA NETWORK (CAN) COMMUNICATION IN POWER SUPPLY SYSTEM

(71) Applicant: HANWHA SOLUTIONS CORPORATION, Seoul (KR)

(72) Inventors: Eun Ji AN, Seoul (KR); Young Cheol KIM, Seoul (KR); Min Ki HONG, Seoul (KR)

(73) Assignee: HANWHA SOLUTIONS CORPORATION, Seoul (KR)

(21) Appl. No.: 19/536,683

(22) Filed: Feb. 11, 2026

(30) Foreign Application Priority Data
Feb. 28, 2025 (KR) 10-2025-0027102

(51) Int. Cl. H02J 13/333

(52) U.S. Cl. CPC H02J 13/333

(57) ABSTRACT

A network and method for performing controller area network (CAN) communication in a power supply system are described. The network for CAN communication performed in a power supply system may include a first CAN communication network for communication between a plurality of first elements included in the power supply system, and a second CAN communication network for communication between a plurality of second elements included in the power supply system, wherein the plurality of first elements include a plurality of elements included in an energy storage system (ESS) of the power supply system, and the plurality of second elements include at least one ESS and at least one element included in the power supply system.

### CROSS-REFERENCE TO RELATED APPLICATION

This application is based on and claims priority under 35 U.S.C. § 119 to Korean Patent Application No. 10-2025-0027102, filed on Feb. 28, 2025, in the Korean Intellectual Property Office, the disclosure of which is incorporated by reference herein in its entirety.

### BACKGROUND

### 1. Field

The present disclosure relates to a network and method for performing controller area network (CAN) communication in a power supply system.

### 2. Description of the Related Art

In a related-art photovoltaic power supply system, controller area network (CAN) communication is performed via a CAN communication network in which a plurality of nodes are connected to a single bus. An energy management system (EMS), a battery management system (BMS), and a main controller (hub), serving as respective nodes, perform CAN communication by communicating over a single bus to share communication data.

This related-art method of performing CAN communication has a problem in that as the number of nodes connected to the bus increases, communication speed may decrease, and a communication failure of a single node may result in a disruption of the entire communication.

In addition, the related-art method of performing CAN communication has a problem in that, because it uses only a single CAN bus, it is impossible to control the internal and external CAN communication of an energy storage system (ESS) at different speeds, resulting in reduced flexibility depending on the installation environment.

Therefore, there is a need for a more efficient network and method for performing CAN communication in a power supply system.

The foregoing background art is technical information that the inventor possessed for deriving the present disclosure or acquired in the course of deriving the present disclosure, and does not necessarily constitute prior art disclosed to the general public prior to the filing of the present disclosure.

### SUMMARY

Provided are a network and method for performing controller area network (CAN) communication in a power supply system. Technical objectives of the present disclosure are not limited to the foregoing, and other unmentioned objects or advantages of the present disclosure would be understood from the following description and be more clearly understood from the embodiments of the present disclosure. In addition, it would be appreciated that the objectives and advantages of the present disclosure may be implemented by means provided in the claims and a combination thereof.

According to a first aspect of the present disclosure, a network for controller area network (CAN) communication performed in a power supply system may include a first CAN communication network for communication between a plurality of first elements included in the power supply system, and a second CAN communication network for communication between a plurality of second elements included in the power supply system, wherein the plurality of first elements include a plurality of elements included in an energy storage system (ESS) of the power supply system, and the plurality of second elements include at least one ESS and at least one element included in the power supply system.

According to a second aspect of the present disclosure, a method of performing CAN communication in a power supply system may include performing CAN communication via a first CAN communication network for communication between a plurality of first elements included in the power supply system, and performing CAN communication via a second CAN communication network for communication between a plurality of second elements included in the power supply system.

According to a third aspect of the present disclosure, a computer-readable recording medium may have recorded thereon a program for causing a computer to execute the method according to the second aspect of the present disclosure.

### BRIEF DESCRIPTION OF THE DRAWINGS

Embodiments of the present disclosure will be described with reference to the accompanying drawings described below, in which like reference numerals denote like elements, but are not limited thereto:

FIG. 1 is an exemplary diagram for schematically describing a power supply system;

FIG. 2 illustrates an example of a power supply system according to an embodiment;

FIG. 3 illustrates an example of a power supply system according to another embodiment;

FIG. 4 is an exemplary diagram for describing an overall configuration of a network for controller area network (CAN) communication performed in a power supply system, according to an embodiment;

FIG. 5 is an exemplary diagram for describing a first CAN communication network according to an embodiment;

FIG. 6 is an exemplary diagram for describing a second CAN communication network according to an embodiment; and

FIG. 7 is a flowchart for describing an overall process of performing CAN communication in a power supply system, according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

Advantages and features of the present disclosure and a method for achieving them will be apparent with reference to embodiments of the present disclosure described below together with the attached drawings. The present disclosure may, however, be embodied in many different forms and should not be construed as being limited to the embodiments set forth herein, and all changes, equivalents, and substitutes that do not depart from the spirit and technical scope of the present disclosure are encompassed in the present disclosure. These embodiments are provided such that the present disclosure will be thorough and complete, and will fully convey the concept of the present disclosure to those of skill in the art. In describing the present disclosure, detailed explanations of the related art are omitted when it is deemed that they may unnecessarily obscure the gist of the present disclosure.

Terms used herein are for describing particular embodiments and are not intended to limit the scope of the present disclosure. Unless otherwise defined, all terms used herein have the same meaning as commonly understood by one of ordinary skill in the art to which the present disclosure belongs.

In the present specification, the singular expression also includes the plural meaning as long as it is not inconsistent with the context. In addition, terms such as “comprises,” “includes,” or “has” specify the presence of stated features, numbers, stages, operations, components, parts, or a combination thereof, but do not preclude the presence or addition of one or more other features, numbers, stages, operations, components, parts, or a combination thereof.

In addition, although terms such as “first” or “second” may be used herein to describe various elements, these elements should not be limited by these terms. These terms are only used to distinguish one element from another element.

As used herein, phrases such as “in an embodiment”, “according to an embodiment”, “regarding an embodiment”, or “according to an implementation of an embodiment” do not necessarily indicate the same embodiment. In addition, throughout the present specification, the term “embodiment” is an arbitrary distinction used to facilitate description of the present disclosure, and the embodiments are not necessarily mutually exclusive. For example, configurations mentioned herein for describing an embodiment may be applied and/or implemented in other embodiments, and may be applied and/or implemented with modifications without departing from the scope of the present disclosure.

Some embodiments of the present disclosure may be represented by functional block components and various processing operations. Some or all of the functional blocks may be implemented by any number of hardware and/or software elements that perform particular functions. For example, the functional blocks of the present disclosure may be embodied by at least one microprocessor or by circuit components for a certain function.

For example, the functional blocks of the present disclosure may be implemented by using various programming or scripting languages. The functional blocks may be implemented by using various algorithms executable by one or more processors. In addition, the present disclosure may employ known technologies for electronic settings, signal processing, and/or data processing. Terms such as “mechanism”, “element”, “unit”, or “component” may be used in a broad sense and are not limited to mechanical or physical components. In addition, terms such as “. . . er”, “. . . or”, or “. . . model” denote a unit that performs at least one function or operation, which may be implemented as hardware or software or a combination thereof.

In addition, connection lines or connection members between components illustrated in the drawings are merely exemplary of functional connections and/or physical or circuit connections. Various alternative or additional functional connections, physical connections, or circuit connections between components may be present in a practical device.

In addition, the size or thickness of some elements in the drawings may be exaggerated. In addition, elements illustrated in one drawing may not be illustrated in another drawing.

Hereinafter, the present disclosure will be described in detail with reference to the accompanying drawings.

The term ‘controller area network (CAN) communication’ may refer to a standard communication protocol designed for microcontrollers or devices to communicate with each other via a CAN bus line.

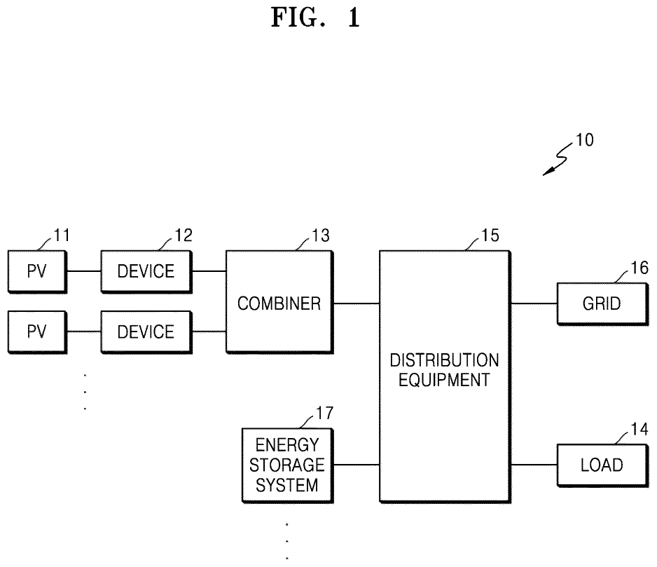

FIG. 1 is an exemplary diagram for schematically describing a power supply system.

Referring to FIG. 1, a power supply system 10 may include a photovoltaic module 11, a device 12, a load 14, and/or distribution equipment 15. The power supply system 10 may be connected to an external grid 16.

At least one photovoltaic module 11 may be installed on a roof or an outer wall of a building to generate power. A plurality of photovoltaic modules 11 may be connected to form a photovoltaic module array.

The photovoltaic module 11 may be connected to the device 12. For example, at least one device 12 may be connected to each photovoltaic module 11. For example, when one device 12 is connected to each photovoltaic module 11, the number of devices 12 constituting the power supply system 10 may be equal to the number of photovoltaic modules 11.

The device 12 may be a power conditioning system (PCS), also known as a power conversion system, that performs power conversion on power generated by the photovoltaic module 11. For example, the device 12 may perform a predetermined conversion on power generated from the photovoltaic module 11, and then supply the converted power to other components of the power supply system 10 (e.g., the grid 16 and/or the load 14).

In some embodiments, the device 12 may be a module-level power electronics (MLPE) device. For example, the device 12 may be an optimizer or a microinverter (MI).

For example, when the device 12 is an optimizer, the device 12 may regulate power produced by the photovoltaic module 11 and output the regulated power to an inverter (e.g., a string inverter). Current converted by the inverter (e.g., from direct current (DC) to alternating current (AC)) may be output to the grid 16 or the load 14.

As another example, when the device 12 is an MI, the device 12 may convert power generated by the photovoltaic module 11 (e.g., from DC to AC). The current converted by the device 12 may be output to the grid 16 or the load 14.

Optionally, the power supply system 10 may further include a combiner 13. At least some of the devices 12 may be connected to the distribution equipment 15 via the combiner 13. For example, power output from a plurality of devices 12 may be combined into a single output at the combiner 13 and then supplied to the distribution equipment 15.

In some embodiments, the device 12 and the distribution equipment 15 may be connected via a power path that does not include the combiner 13. Alternatively, at least one device 12 may be connected to the distribution equipment 15 via a power path that does not include the combiner 13, while at least one other device 12 may be connected to the distribution equipment 15 via the combiner 13.

The combiner 13 may control voltage, current, and/or power output from the device 12 according to a power supply state of the photovoltaic module 11, the device 12, and/or the grid 16, and set an operation mode of the combiner 13 to a diagnosis mode, a driving mode, or the like.

In addition, the combiner 13 may include an energy management system (EMS) that controls the operation of the combiner 13. The EMS may control voltage, current, and/or power supplied to or output from the combiner 13 according to a power supply state of the photovoltaic module 11, the device 12, and/or the grid 16, and set the operation mode of the combiner 13 to the diagnosis mode, the driving mode, or the like.

The load 14 refers to an object installed at an electric consumer's premises, such as a residence, a commercial facility, or a factory, and that operates by receiving at least one of energy generated by the photovoltaic module 11, energy stored in an energy storage system 17, and energy supplied from the grid 16. For example, when the power is supplied to a residence, the load 14 may include home appliances such as a washing machine, a refrigerator, or a television (TV).

The grid 16 may include an infrastructure system for generating, transmitting, and distributing power. For example, the grid 16 may include an infrastructure system such as a power plant, a substation, or a power line network. In some embodiments, the grid 16 may deliver electrical energy generated at a power plant to the power supply system 10, or deliver surplus power generated by the power supply system 10 to the outside of the power supply system 10.

For example, commercial power transmitted from the grid 16 through utility poles may be supplied to an electric consumer through a transformer. In some embodiments, the power supply system 10 may be implemented as an off-grid system that is not connected to the grid 16.

In some embodiments, the power supply system 10 may further include at least one energy storage system 17. Optionally, the power supply system 10 may include a plurality of energy storage systems 17. The energy storage system 17 may receive and store power generated by the photovoltaic module 11 and/or power delivered from the grid 16. The energy storage system 17 may efficiently supply power by storing power and then supplying the power to the load 14 when required by the load 14.

The energy storage system 17 may include a battery that stores power and a power conversion module. The battery may include a battery management system (BMS) configured to monitor a state of charge (SoC), a state of health (SoH), a voltage, and/or a current of the battery, perform diagnosis on the battery, and perform safety functions such as current interruption.

In some embodiments, the power conversion module may be a PCS configured to perform conversion between battery-side power and opposite-side power. For example, the PCS may perform conversion between battery-side DC and opposite-side AC. For example, the PCS may include a bidirectional DC-DC converter connected to the battery and configured to convert a voltage, and a bidirectional inverter connecting the DC-DC converter to the outside of the energy storage system 17.

In some embodiments, the energy storage system 17 may further include an EMS configured to control the operation of the energy storage system 17. The EMS may control voltage, current, and/or power supplied to or output from the energy storage system 17 according to a power supply state of the battery and/or the grid 16, and may set an operation mode of the energy storage system 17 to a diagnosis mode, a driving mode, or the like.

Optionally, an EMS coupled to a predetermined component of the power supply system 10 may control the operation of other components of the power supply system 10 as well as the operation of the predetermined component. For example, the EMS coupled to the combiner 13 or the EMS coupled to the energy storage system 17 may control both the operation of the combiner 13 and the operation of the energy storage system 17.

In some embodiments, the distribution equipment 15 may provide electrical connections between components of the power supply system 10 and control a power flow in the power supply system 10. For example, the distribution equipment 15 may electrically connect the photovoltaic module 11 to the load 14. For example, the distribution equipment 15 may be connected to the device 12, which is connected to the photovoltaic module 11, so as to electrically connect the photovoltaic module 11 to the load 14. Optionally, the distribution equipment 15 may be further connected to at least one of the energy storage system 17 and the grid 16.

For example, the distribution equipment 15 may be a distribution panel configured to distribute power within the power supply system 10. For example, the distribution equipment 15 may be a master service panel (MSP) configured to distribute power generated by the photovoltaic module 11 to the load 14 and the like.

As another example, the distribution equipment 15 may be a main controller configured to perform power distribution within the power supply system and control each device 12. For example, the main controller may include a switch, a breaker, and a control unit. The switch, the breaker, and the control unit may be implemented as independent devices, respectively, or at least some of the switch, the breaker, and the control unit may be included in a single device.

The main controller may include a switch configured to control electrical connections between components connected to the main controller, such as the device 12 or the load 14. For example, the main controller may include a relay, a power semiconductor, or the like, configured to provide or cut off an electrical connection to the device 12 and/or the energy storage system 17 according to an operation state of each component of the power supply system 10.

The main controller may perform a rapid shutdown to stop power generation of the photovoltaic module 11 in an emergency situation, such as when overcurrent occurs in the power supply system 10. To this end, the main controller may include a breaker configured to cut off a connection between the device 12 and the load 14.

The main controller may include a control unit configured to control the overall operation of the main controller. The control unit may control the operation of other components of the power supply system 10 (e.g., the device 12 or the energy storage system 17) in addition to the main controller.

The control unit may control voltage, current, and/or power output from or supplied to each component according to a power supply state of the photovoltaic module 11, the device 12, the combiner 13, the load 14, the grid 16, and/or the energy storage system 17. In addition, the control unit may set an operation mode of the main controller, the device 12, and/or the energy storage system 17 to a diagnosis mode, a driving mode, or the like.

For example, the control unit may control the photovoltaic module 11, the device 12, the combiner 13, and/or the energy storage system 17 based on a state of the power supply system 10. For example, the control unit may control other components (e.g., the device 12) of the power supply system 10 by causing the main controller to perform communication with the other components of the power supply system 10. Communication between the main controller and other components of the power supply system 10 may be performed by using a power-line communication (PLC) scheme or a CAN communication scheme, but is not limited thereto.

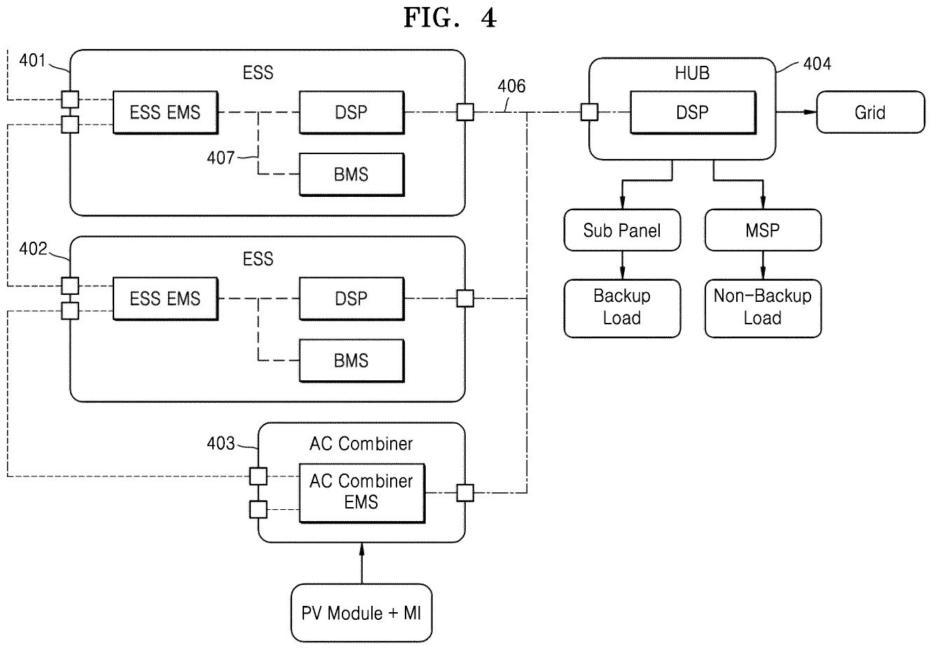

In addition, communication between the main controller and other components of the power supply system 10 illustrated in FIG. 1 or communication between respective components of the power supply system 10 may be performed via a second CAN communication network to be described below with reference to FIGS. 4 to 7, but is not limited thereto.

For example, the control unit may control the device 12 according to a power generation state of the photovoltaic module 11. For example, the main controller may receive a control command from a server that monitors the power generation state of the photovoltaic module 11, and the control unit may control the device 12 according to the control command.

When the power supply from the grid 16 is unstable (e.g., in an off-grid situation), the main controller may supply power to at least some of the loads 14. For example, when power supply from the grid 16 is unstable, the main controller may preferentially supply power generated by the photovoltaic module 11 and/or power stored in the energy storage system 17 to a backup load having a relatively high necessity for stable power supply.

In some embodiments, the power supply system 10 may further include an auxiliary power generation device (e.g., a diesel generator) that generates power by a method other than photovoltaic power generation. For example, an auxiliary power generation device may be further connected to the distribution equipment 15. When the photovoltaic module 11 and the energy storage system 17 alone cannot support the backup load due to environmental factors such as time of day or weather, the main controller may supply power generated by the auxiliary power generation device to the backup load.

The control unit may be implemented by at least one processor. The processor may process instructions of a computer program by performing basic arithmetic, logic, and input/output operations. Here, the instructions may be provided from an internal memory of the main controller, or from an external device. In addition, the processor may control the overall operation of other components included in the main controller.

In addition, the processor may perform at least a part of data analysis, processing, and result information generation for performing the above-described operations, by using at least one of machine learning, a neural network, or a deep learning algorithm, as a rule-based or artificial intelligence algorithm. Examples of the neural network may include neural network models based on architectures such as a convolutional neural network (CNN), a deep neural network (DNN), or a recurrent neural network (RNN).

For example, the processor may be implemented as an array of a plurality of logic gates, or may be implemented as a combination of a general-purpose microprocessor and a memory storing a program executable by the microprocessor. For example, the processor may include a general-purpose processor, a central processing unit (CPU), a microprocessor, a digital signal processor (DSP), a controller, a microcontroller, a state machine, and the like.

In some environments, the processor may include an application-specific integrated circuit (ASIC), a programmable logic device (PLD), a field-programmable gate array (FPGA), and the like. For example, the processor may refer to a combination of processing devices, such as a combination of a DSP and a microprocessor, a combination of a plurality of microprocessors, a combination of one or more microprocessors combined with a DSP core, or a combination of any other such configurations.

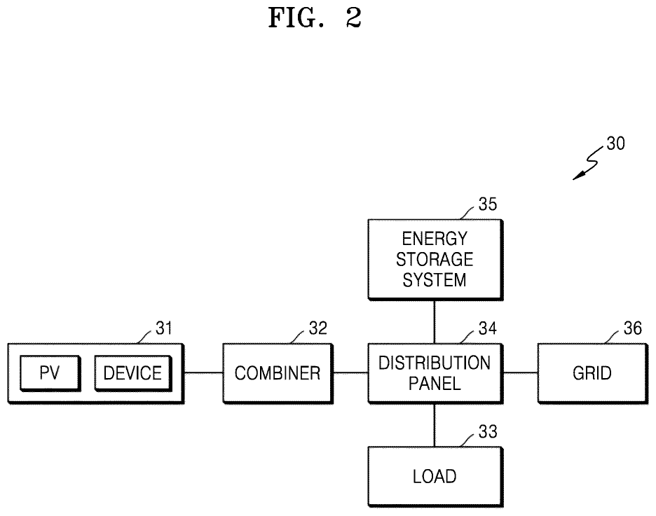

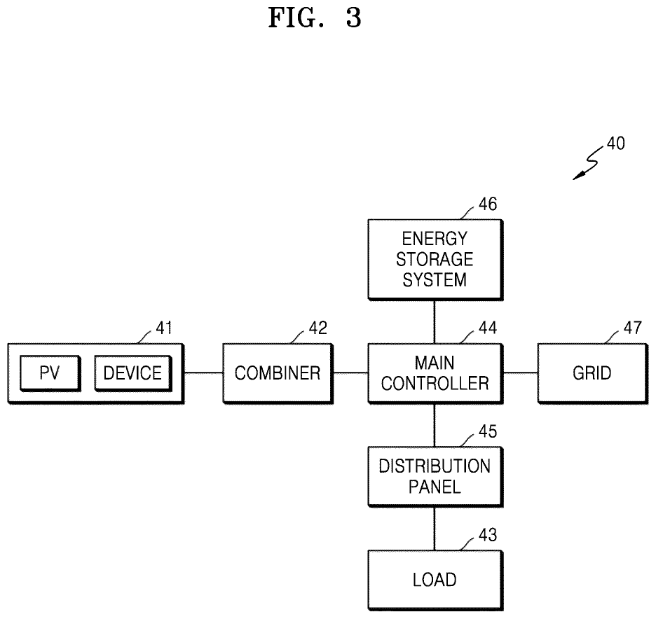

By combining at least some of the above-described components, the power supply system 10 may be implemented in various forms. Hereinafter, various embodiments of the power supply system 10 will be described with reference to FIGS. 2 and 3. However, the implementation of the power supply system 10 is not limited to the embodiments described below.

FIG. 2 illustrates an example of a power supply system according to an embodiment.

Referring to FIG. 2, a power supply system 30 according to an embodiment may include a photovoltaic power generation device 31, a combiner 32, a load 33, a distribution panel 34, and an energy storage system 35. In addition, the power supply system 30 may be connected to a power grid 36 located externally.

In an embodiment, the energy storage system 35 may be connected to the distribution panel 34 to be charged or discharged. In another embodiment, the energy storage system 35 may be connected to the combiner 32 to be charged or discharged.

Because the power supply system 30 further includes the energy storage system 35, power stored in the energy storage system 35 may be used to support the load 33 when the photovoltaic power generation device 31 alone is insufficient to support the load 33. In addition, when power generated by the photovoltaic power generation device 31 exceeds an amount of power required to support the load 33, the excess may be stored in the energy storage system 35. In some embodiments, when a charge amount of the energy storage system 35 is below a threshold and the power generated by the photovoltaic power generation device 31 does not exceed the amount of power required to support the load 33, the energy storage system 35 may be charged with power supplied from the power grid 36.

Through this, the power supply system 30 may perform efficient power supply to the load 33 by using the energy storage system 35.

The combiner 32 may control voltage, current, and/or power output from the photovoltaic power generation device 31 according to a power supply state of the photovoltaic power generation device 31, the load 33, and/or the power grid 36, and may set an operation mode of the combiner 32 to a diagnosis mode, a driving mode, or the like.

In addition, the energy storage system 35 may control voltage, current, and/or power supplied to or output from the energy storage system 35 according to a power supply state of the photovoltaic power generation device 31, the load 33, and/or the power grid 36, and may set an operation mode of the energy storage system 35 to a diagnosis mode, a driving mode, or the like.

In an embodiment, the power supply system 30 may further include a sub-panel (not shown) connected to the distribution panel 34. In this case, at least one photovoltaic power generation device 31 may be connected to the sub-panel via the combiner 32, and at least one other photovoltaic power generation device 31 may be directly connected to the sub-panel.

In addition, at least one energy storage system 35 may be connected to the combiner 32, the distribution panel 34, or the sub-panel and integrated into the power supply system 30.

In some embodiments, at least one photovoltaic power generation device 31 may be connected to the distribution panel 34 via a power path that does not include the combiner 32. For example, at least one photovoltaic power generation device 31 may be connected to the distribution panel 34 via a power path that does not include the combiner 32, and at least one other photovoltaic power generation device 31 may be connected to the distribution panel 34 via the combiner 32.

In an embodiment, at least one photovoltaic power generation device 31 may be connected to the sub-panel via the combiner 32, and at least one other photovoltaic power generation device 31 may be directly connected to the sub-panel.

By including the sub-panel that provides additional capacity, the power supply system 30 may increase a total amount of power generation of the photovoltaic power generation devices 31 that may be integrated into the power supply system 30.

In addition, communication between the distribution panel 34 and other components of the power supply system 30 illustrated in FIG. 2 or communication between respective components of the power supply system 30 may be performed via a second CAN communication network to be described below with reference to FIGS. 4 to 7, but is not limited thereto.

FIG. 3 illustrates an example of a power supply system according to another embodiment.

Referring to FIG. 3, a power supply system 40 according to an embodiment may include a photovoltaic power generation device 41, a combiner 42, a load 43, a main controller 44, a distribution panel 45, and an energy storage system 46. In addition, the power supply system 40 may be connected to an external grid 47.

Here, the photovoltaic power generation device 41, the combiner 42, the load 43, and the energy storage system 46 illustrated in FIG. 3 may correspond to the photovoltaic power generation device 31, the combiner 32, the load 33, and the energy storage system 35 illustrated in FIG. 2, respectively. In addition, the main controller 44 illustrated in FIG. 3 may correspond to the main controller described above with reference to FIG. 1.

The combiner 42 may electrically connect at least one photovoltaic power generation device 41 to the main controller 44. For example, the combiner 42 may combine power output from the at least one photovoltaic power generation device 41 into a single output and then supply the combined power to the main controller 44.

The main controller 44 may electrically connect the combiner 42, the distribution panel 45, and the grid 47 to each other. In addition, the main controller 44 may connect the above-described components to the energy storage system 46 and/or an auxiliary power source such as an auxiliary power generation device (e.g., a diesel generator). For example, the main controller 44 may output power supplied from the combiner 42, to the distribution panel 45, the energy storage system 46, and/or the grid 47. In addition, the main controller 44 may output power supplied from the grid 47, to the distribution panel 45 or the energy storage system 46. In addition, the main controller 44 may output power supplied from the energy storage system 46, to the distribution panel 45.

The distribution panel 45 may electrically connect the main controller 44 to at least one load 43. Accordingly, the power supply system 40 may supply power generated by the photovoltaic power generation device 41 to the load 43 via the distribution panel 45.

Because the power supply system 40 includes the main controller 44, a plurality of energy storage systems 46 and/or auxiliary power generation devices may be integrated into the power supply system 40, thereby enabling a stable supply of power. In addition, even in an off-grid environment where the power supply system 40 cannot stably receive power from the grid 47, power may be stably supplied to the load 43 such as a backup load.

The main controller 44 may control voltage, current, and/or power output from or supplied to each component according to a state of the photovoltaic power generation device 41, the load 43, the energy storage system 46, and/or the grid 47, and may set an operation mode of the main controller 44, the photovoltaic power generation device 41, and/or the energy storage system 46 to a diagnosis mode, a driving mode, or the like.

In an embodiment, the power supply system 40 may further include a sub-panel (not shown) connected to the main controller 44 and separate from the distribution panel 45. In this case, at least one backup load having a relatively high necessity for stable power supply among the loads 43 may be connected to the sub-panel, and at least one non-backup load having a relatively low necessity for stable power supply among the loads 43 may be connected to the distribution panel 45.

The main controller 44 may electrically connect the combiner 42, the distribution panel 45, the energy storage system 46, the grid 47, and the sub-panel to each other. The main controller 44 may supply power supplied from the combiner 42, the energy storage system 46, and/or the grid 47, to at least one non-backup load via the distribution panel 45, and to a backup load via the sub-panel.

In addition, in an embodiment, the power supply system 40 may further include a sub-panel connected to the main controller 44 and separate from the distribution panel 45, and the grid 47 may be connected to the distribution panel 45 instead of being connected to the main controller 44. That is, the main controller 44 may electrically connect the combiner 42, the distribution panel 45, the energy storage system 46, and the sub-panel to each other, and the distribution panel 45 may electrically connect the main controller 44, the non-backup load, and the grid 47 to each other.

For example, the power supply system 40 may be implemented by connecting the main controller 44, which connects the combiner 42 to the energy storage system 46, to the distribution panel 45 that is pre-installed to connect at least one load 43 to the grid 47.

Accordingly, even in an off-grid environment where the power supply system 40 cannot stably receive power from the grid 47, power may be stably supplied to the load 43 such as a backup load.

In addition, communication between the main controller 44 and other components of the power supply system 40 illustrated in FIG. 3 or communication between respective components of the power supply system 40 may be performed via a second CAN communication network to be described below with reference to FIGS. 4 to 7, but is not limited thereto.

FIG. 4 is an exemplary diagram for describing an overall configuration of a network for CAN communication performed in a power supply system, according to an embodiment.

FIG. 4 illustrates a power supply system including a first energy storage system 401, a second energy storage system 402, an AC combiner 403, a main controller 404, a first CAN communication network 407, and a second CAN communication network 406.

According to an embodiment, the first CAN communication network 407 may perform CAN communication inside the first energy storage system 401 and inside the second energy storage system 402.

In other words, the first CAN communication network 407 may perform CAN communication between a plurality of first elements included in the power supply system.

Here, the first elements may include a plurality of elements included in the energy storage systems of the power supply system, and the first elements may include EMSs, DSPs, and BMSs.

In detail, a BMS in the energy storage system may transmit status information to any one of the main controller 404 or an EMS via the DSP, and receive a control signal from any one of the main controller or the EMS.

Here, the control signal may refer to a signal that is generated by the main controller 404 or the EMS to adjust a power flow for the purpose of load control, power control, battery management, or the like.

In addition, the status information may refer to information that is generated by the BMS, the energy storage system, or the like, and includes information about the voltage, current, temperature, current remaining capacity, SoH, SoC, protection state, and the like of a battery.

According to another embodiment, the second CAN communication network 406 may perform CAN communication between a plurality of second elements included in the power supply system.

Here, the second elements may include a plurality of energy storage systems, the main controller 404, and the AC combiner 403.

In detail, the main controller 404 may be connected in parallel to the plurality of energy storage systems via a single communication line, and may receive status information from any one of the AC combiner 403 or a BMS, and transmit a control signal to any one of the AC combiner 403 or an EMS.

According to another embodiment, because the first CAN communication network 407 and the second CAN communication network 406 use respective CAN communication networks with separated communication lines, they may perform communication at different speeds.

Through this configuration, the present disclosure may offer flexibility in configuring communication speeds for diverse installation environments, as it allows the communication speed to be determined in consideration of variations in CAN communication line lengths resulting from the placement of respective components.

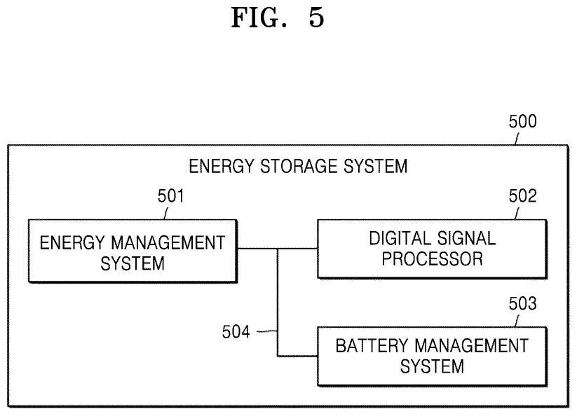

FIG. 5 is an exemplary diagram for describing a first CAN communication network according to an embodiment.

FIG. 5 illustrates an energy storage system 500, an EMS 501, a DSP 502, a BMS 503, and a first CAN communication network 504.

According to an embodiment, the first CAN communication network 504 may perform CAN communication between a plurality of first elements within the energy storage system 500.

In detail, the EMS 501 may generate a control signal and transmit the control signal to the DSP 502 via the first CAN communication network 504.

In addition, the EMS 501 may monitor status information of the BMS 503 and perform a remote update on the BMS 503 as needed.

In addition, the BMS 503 may transmit status information to any one of the main controller 404 or the EMS 501 via the DSP 502.

According to another embodiment, the DSP 502 may process communication data based on a CAN identifier (ID) and transmit, to the main controller 404, a control signal received from the EMS 501.

In addition, in response to a destination included in the CAN ID corresponding to the EMS 501, the DSP 502 may transmit the CAN ID to the EMS 501.

For example, in a CAN ID consisting of 32 bits, the 20th to 23rd bits may be allocated for a bit value corresponding to a source, and the 16th to 19th bits may be allocated for a bit value corresponding to a destination. In this case, the main controller 404 may transmit the CAN ID to the DSP 502, and the DSP 502 may finally transmit the CAN ID to the EMS 501 in response to the bit value corresponding to the destination in the CAN ID indicating the EMS 501.

Conversely, the DSP 502 may transmit the CAN ID to the main controller 404 in response to the destination included in the CAN ID corresponding to the main controller 404.

For example, in response to the bit value corresponding to the destination indicating the main controller 404, the EMS 501 may transmit the CAN ID to the DSP 502, and the DSP 502 may finally transmit the CAN ID to the main controller 404.

According to another embodiment, the DSP 502 may include a first CAN communication module configured to perform CAN communication with the EMS 501, and a second CAN communication module configured to perform communication with the main controller 404. In detail, the first CAN communication module of the DSP 502 may perform CAN communication with the EMS 501, and the second CAN communication module of the DSP 502 may perform CAN communication with the main controller 404.

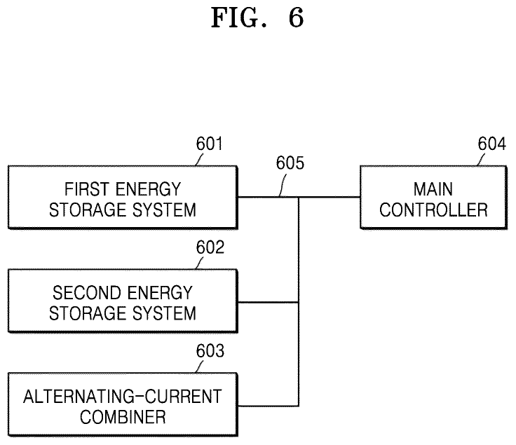

FIG. 6 is an exemplary diagram for describing a second CAN communication network according to an embodiment.

FIG. 6 illustrates the first energy storage system 601, the second energy storage system 602, an AC combiner 603, a main controller 604, and a second CAN communication network 605. In this case, the first energy storage device 601 may correspond to the first energy storage device 401 illustrated in FIG. 4. In some embodiments, the second energy storage device 602 may correspond to the second energy storage device 402 illustrated in FIG. 4.

According to an embodiment, the main controller 604 may generate a control signal. The main controller 604 may transmit the generated control signal to any one of the first energy storage system 601, the second energy storage system 602, or the AC combiner 603 via the second CAN communication network 605.

In detail, the main controller 604 may receive at least one of status information or a control signal transmitted from the first energy storage system 601 via the second CAN communication network 605.

Similarly, the main controller 604 may receive at least one of status information or a control signal transmitted from the second energy storage system 602 via the second CAN communication network 605.

In addition, the main controller 604 may receive at least one of status information or a control signal transmitted from the AC combiner 603 via the second CAN communication network 605.

CAN communication between the EMS 501 and the main controller 604 may be performed via the second CAN communication network 605 and the DSP 502. In detail, the first CAN communication module of the DSP 502 may perform CAN communication with the EMS 501, and the second CAN communication module of the DSP 502 may perform CAN communication with the main controller 604.

As described above, the first CAN communication network 504 and the second CAN communication network 605 that are connected to different CAN lines may perform CAN communication with each other via the DSP 502 including the first CAN communication module and the second CAN communication module.

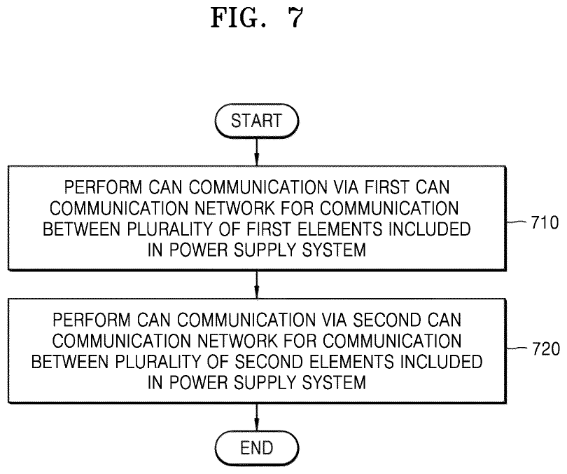

FIG. 7 is a flowchart for describing an overall process of performing CAN communication in a power supply system, according to an embodiment.

Referring to FIG. 7, in operation 710, the first CAN communication network 407 may perform CAN communication between a plurality of first elements included in the power supply system.

Here, the first elements may include a plurality of elements included in an energy storage system of the power supply system.

According to an embodiment, the first CAN communication network 407 may perform CAN communication inside the first energy storage system 401 and inside the second energy storage system 402.

In detail, the EMS 501 may generate a control signal and transmit the control signal to the DSP 502 via the first CAN communication network 504.

In addition, the EMS 501 may monitor status information of the BMS 503 and perform a remote update on the BMS 503 as needed.

In operation 720, the second CAN communication network 406 may perform CAN communication between a plurality of second elements included in the power supply system.

Here, the second elements may include at least one energy storage system and at least one element included in the power supply system.

According to an embodiment, the second CAN communication network 406 may perform CAN communication between the plurality of second elements included in the power supply system.

Here, the second elements may include a plurality of energy storage systems, the main controller 404, and the AC combiner 403.

In detail, the main controller 404 may be connected in parallel to the plurality of energy storage systems via a single communication line, and may receive status information from any one of the AC combiner 403 or a BMS, and transmit a control signal to any one of the AC combiner 403 or an EMS.

According to the means for solving the problems, internal and external CAN communication speeds of an energy storage system may be independently configured via separate CAN communication networks, enabling the advantage of flexibility in adjusting communication speeds depending on the situation.

The above-described devices may be implemented as computer-readable code on a computer-readable recording medium. The computer-readable recording medium includes all types of recording devices storing data readable by a computer system. Examples of the computer-readable recording medium include read-only memory (ROM), random-access memory (RAM), compact disc ROM (CD-ROM), magnetic tape, floppy disk, and optical data storage device. In addition, the computer-readable recording medium may be distributed over network-connected computer systems such that computer-readable code is stored and executed in a distributed manner. Furthermore, functional programs, code, and code segments for implementing the above embodiments may be easily derived by programmers in the technical field to which the present disclosure belongs.

The techniques described herein may be implemented by various means. For example, these techniques may be implemented by hardware, firmware, software, or a combination thereof. Those skilled in the art would further appreciate that various illustrative logical blocks, models, circuits, and algorithm steps described in connection with the present disclosure herein may be implemented as electronic hardware, computer software, or combinations of both. To clearly illustrate this interchangeability of hardware and software, various illustrative components, blocks, models, circuits, and steps have been described above generally in terms of their functionality. Whether such functionality is implemented as hardware or software depends on a particular application and design constraints imposed on the overall system. Those skilled in the art may implement the described functionality in varying ways for each particular application, but such implementation decisions should not be interpreted as causing a departure from the scope of the present disclosure.

In a hardware implementation, processing units used to perform the techniques may be implemented within one or more application-specific integrated circuits (ASICs), DSPs, digital signal processing devices (DSPDs), programmable logic devices (PLDs), field-programmable gate arrays (FPGAs), processors, controllers, microcontrollers, microprocessors, electronic devices, other electronic units designed to perform the functions described herein, a computer, or a combination thereof.

Accordingly, various illustrative logical blocks, models, and circuits described in connection with the present disclosure may be implemented or performed with a general-purpose processor, a DSP, an ASIC, an FPGA or other programmable logic device, discrete gate or transistor logic, discrete hardware components, or any combination thereof designed to perform the functions described herein. The general-purpose processor may be a microprocessor, but in the alternative, the processor may be any conventional processor, controller, microcontroller, or state machine. The processor may also be implemented as a combination of computing devices, e.g., a combination of a DSP and a microprocessor, a plurality of microprocessors, one or more microprocessors in conjunction with a DSP core, or a combination of any other such configurations.

In a firmware and/or software implementation, the techniques may be implemented as instructions stored on a computer-readable medium such as RAM, ROM, non-volatile RAM (NVRAM), programmable ROM (PROM), erasable programmable ROM (EPROM), electrically erasable PROM (EEPROM), flash memory, a CD, or a magnetic or optical data storage device. The instructions may be executable by one or more processors and may cause the processor(s) to perform certain aspects of the functionality described herein.

When implemented in software, the functions may be stored on a computer-readable medium or transmitted via a computer-readable medium as one or more instructions or code. The computer-readable media include both computer storage media and communication media, including any medium that facilitates transfer of a computer program from one place to another. The storage media may be any available media that may be accessed by a computer. By way of non-limiting example, such computer-readable media may include RAM, ROM, EEPROM, a CD-ROM or other optical disk storage, a magnetic disk storage or other magnetic storage devices, or any other medium that may be used to carry or store desired program code in the form of instructions or data structures and that may be accessed by a computer. Also, any connection is properly termed a computer-readable medium.

For example, when the software is transmitted from a website, server, or other remote source by using a coaxial cable, a fiber optic cable, a twisted pair, a digital subscriber line (DSL), or wireless technologies such as infrared, radio, or microwave, the coaxial cable, fiber optic cable, twisted pair, DSL, or wireless technologies such as infrared, radio, or microwave are included in the definition of medium. Disks and discs, as used herein, include CDs, laser discs, optical discs, digital versatile discs (DVDs), floppy disks, and Blu-ray discs, wherein disks usually reproduce data magnetically, while discs reproduce data optically by using lasers. Combinations of the above should also be included within the scope of computer-readable media.

A software model may reside in a RAM memory, a flash memory, a ROM memory, an EPROM memory, an EEPROM memory, registers, a hard disk, a removable disk, a CD-ROM, or any other form of storage medium known in the art. An exemplary storage medium may be coupled to the processor such that the processor reads information from, and writes information to, the storage medium. Alternatively, the storage medium may be integrated into the processor. The processor and the storage medium may reside in an ASIC. The ASIC may reside in a user terminal. Alternatively, the processor and the storage medium may reside as discrete components in a user terminal.

The previous description of the present disclosure is provided to enable any person skilled in the art to make or use the present disclosure. Various modifications to the present disclosure would be readily apparent to those skilled in the art, and the generic principles defined herein may be applied to various variations without departing from the spirit or scope of the present disclosure. Thus, the present disclosure is not intended to be limited to the examples described herein but is to be accorded the widest scope consistent with the principles and novel features disclosed herein.

Although the present subject matter has been described in language specific to structural features and/or methodological acts, it is to be understood that the subject matter defined in the appended claims is not necessarily limited to the specific features or acts described above. Rather, the specific features and acts described above are described as example forms of implementing the claims.

Although the method mentioned in the present specification has been described through specific embodiments, it is possible to implement it as computer-readable code on a computer-readable recording medium. The computer-readable recording medium includes all types of recording devices storing data readable by a computer system. Examples of the computer-readable recording medium include ROM, RAM, CD-ROM, magnetic tape, floppy disk, and optical data storage device. In addition, the computer-readable recording medium may be distributed over network-connected computer systems such that computer-readable code is stored and executed in a distributed manner. Furthermore, functional programs, code, and code segments for implementing the embodiments may be easily derived by programmers in the technical field to which the present disclosure belongs.

Although the present disclosure has been described in connection with some embodiments herein, various modifications and changes may be made without departing from the scope of the present disclosure as understood by those skilled in the art to which the present disclosure belongs. In addition, such modifications and changes should be considered to fall within the scope of the appended claims.

What is claimed is:

1. A network for controller area network (CAN) communication performed in a power supply system, the network comprising:
a first CAN communication network for communication between a plurality of first elements included in the power supply system; and
a second CAN communication network for communication between a plurality of second elements included in the power supply system,
wherein the plurality of first elements include a plurality of elements included in an energy storage system (ESS) of the power supply system, and
the plurality of second elements include at least one ESS and at least one element included in the power supply system.

2. The network of claim 1, wherein the plurality of first elements include an energy management system (EMS), a digital signal processor (DSP), and a battery management system (BMS).

3. The network of claim 2, wherein the plurality of second elements include plurality of ESSs, a main controller (hub), and an alternating-current (AC) combiner.

4. The network of claim 3, wherein the BMS is configured to transmit status information to the main controller via the DSP, and receive a control signal from the main controller via the DSP.

5. The network of claim 3, wherein the main controller is connected in parallel to the plurality of ESSs by a single communication line, and configured to receive status information from any one of the AC combiner or the BMS, and transmit a control signal to any one of the AC combiner or the EMS.

6. The network of claim 3, wherein the first CAN communication network and the second CAN communication network are configured to perform communication at different speeds, respectively.

7. The network of claim 3, wherein the DSP is configured to process communication data based on a CAN identifier (ID), and transmit, to the main controller, a control signal received from the EMS.

8. The network of claim 7, wherein the DSP is configured to transmit, in response to a destination included in the CAN ID corresponding to the EMS, the CAN ID to the EMS, and transmit, in response to the destination included in the CAN ID corresponding to the main controller, the CAN ID to the main controller.

9. The network of claim 7, wherein the digital signal processor includes:
a first CAN communication module configured to perform CAN communication with the EMS; and
a second CAN communication module configured to perform CAN communication with the main controller.

10. A method of performing controller area network (CAN) communication in a power supply system, the method comprising:
performing CAN communication via a first CAN communication network for communication between a plurality of first elements included in the power supply system; and
performing CAN communication via a second CAN communication network for communication between a plurality of second elements included in the power supply system,
wherein the plurality of first elements include a plurality of elements included in an energy storage system of the power supply system, and
the plurality of second elements include at least one energy storage system and at least one element included in the power supply system.

11. The method of claim 10, wherein the plurality of first elements include an energy management system, a digital signal processor, and a battery management system.

12. The method of claim 11, wherein the plurality of second elements include plurality of energy storage systems, a main controller (hub), and an alternating-current (AC) combiner.

13. The method of claim 12, wherein the battery management system is configured to transmit status information to the main controller via the digital signal processor, and receive a control signal from the main controller via the digital signal processor.

14. The method of claim 12, wherein the main controller is connected in parallel to the plurality of energy storage systems by a single communication line, and configured to receive status information from any one of the AC combiner or the battery management system, and transmit a control signal to any one of the AC combiner or the energy management system.

15. The method of claim 12, wherein the first CAN communication network and the second CAN communication network are configured to perform communication at different speeds, respectively.

16. The method of claim 12, wherein the digital signal processor is configured to process communication data based on a CAN identifier (ID), and transmit, to the main controller, a control signal received from the energy management system.

17. The method of claim 16, wherein the digital signal processor is configured to transmit, in response to a destination included in the CAN ID corresponding to the energy management system, the CAN ID to the energy management system, and transmit, in response to the destination included in the CAN ID corresponding to the main controller, the CAN ID to the main controller.

18. The method of claim 16, wherein the digital signal processor includes:
a first CAN communication module configured to perform CAN communication with the energy management system; and
a second CAN communication module configured to perform CAN communication with the main controller.

19. A computer-readable recording medium having recorded thereon a program for causing a computer to execute the method of claim 10.
